(19) United States
(12) Patent Application Publication
(10) Pub. No.: US 2016/0195858 A1
(43) Pub. Date: Jul. 7, 2016

(54) Home Automation Device, Method for Automating At Least Two Home Appliances with a Different Data Communication Protocol with a Home Automation Device, and Combination of a First and Second Home Appliance and a Home Automation Device

(71) Applicant: Cluetechnologies B.V., Amsterdam-Duivendrecht (NL)

(72) Inventors: Sebastiaan Schalbroeck, 's-Gravenhage (NL); Wessel van Waas, Gouda (NL); Frank Coster, 's-Gravenhage (NL)

(21) Appl. No.: 14/589,419

(22) Filed: Jan. 5, 2015

(51) Int. Cl. G05B 15/02; H04L 12/28

(52) U.S. Cl. CPC G05B 15/02; H04L 12/2816

(57) ABSTRACT

The invention relates to a home automation device, including:
a housing;
at least two communication interfaces for connecting to and communicating with at least one home appliance through a data communication protocol, wherein each of the communication interfaces uses a different data communication protocol, and wherein each of the communication interfaces is arranged within the housing; and
a controller, connected to each of the communication interfaces, for coordinating the communication interfaces, wherein the controller comprises conversion means for converting a signal from a first communication interface to a signal for a second communication interface.

The invention further relates to a method for automating at least two home appliances with a different data communication protocol with a home automation device.

The invention further relates to a combination of a first and second home appliance and a home automation device according to the invention.

### BACKGROUND OF THE INVENTION

1. Field of the Invention

The invention relates to a home automation device, to a method for automating at least two home appliances with a different data communication protocol with a home automation device, and to a combination of a first and second home appliance and a home automation device.

2. Description of Related Art

The field of home automation is the field of integration of home appliances with each other (into a home automation system), which allows home appliances to adjust their behavior on information received from other appliances. The information may also be received from a resident of the home through the Internet, for instance through the mobile phone of the resident of the home, even when the resident is abroad.

Home appliances which may be automated using home automation are for instance, but are not limited to lighting, heating, ventilation, shading or security systems, electrical devices such as refrigerators, televisions, entertainment systems, cooking appliances, swimming pools, phones, et cetera.

In home automation, there is however no generally accepted standard for a data communication protocol used for exchanging information. As a consequence, the group of home appliances which is able to exchange information through one data communication protocol will be isolated from the group of home appliances from a second different data communication protocol. This reduces the efficiency of the home automation system in total.

### SUMMARY OF THE INVENTION

It is now an object of the invention to alleviate or even obviate the abovementioned drawbacks.

This object is achieved with a home automation device, comprising:
a housing;
at least two communication interfaces for connecting to and communicating with at least one home appliance through a data communication protocol, wherein each of the communication interfaces uses a different data communication protocol, and wherein each of the communication interfaces is arranged within the housing; and
a controller, connected to each of the communication interfaces, for coordinating the communication interfaces, wherein the controller comprises conversion means for converting a signal from a first communication interface to a signal for a second communication interface.

In the home automation device, at least two communication interfaces are arranged enclosed within a housing. Because the home automation device is provided with communication interfaces for different data communication protocols, the home automation device will be able to communicate with each of the home appliances supporting one of these data communication protocols in order to adapt the behavior of the appliances to each other. Through the conversion means, the home automation device will be able to convert the information received through a first communication interface into information suitable for a second communication interface.

In this respect, “communication interface” not only refers to the physical connector, but also to the control circuit of this communication interface which is connected to the controller.

The controller, conversion means and at least one of the communication interfaces may be arranged on a circuit board within the housing. The conversion means may be integrated in the controller.

The controller may comprise a processor and a microcontroller. In that case, a part of the communication interfaces may be connected to the processor, whereas the remaining communication interfaces are connected to the microcontroller.

The home automation device may be powered by mains electricity, but may also as an auxiliary measure, in order to cover power outages, or alternatively, be provided with a battery.

In a first preferred embodiment of the home automation device according to the invention, at least one of the communication interfaces is a wireless interface.

While the communication interfaces may be wired, i.e. may require wires to exchange information from the interface with a home appliance, at least one of the communication interfaces is wireless. The different wireless communication interfaces may be selected from the list of ZigBee, RF 433, wi-fi (such as 802.11a, b, g, n or ac), Bluetooth (such as version 4.0), RF 868 and Z-Wave. Preferably, all of these wireless communication interfaces are available within the home automation device. Other communication interfaces suitable for exchanging information with home appliances are also a possibility.

Preferably, all of the communication interfaces are wireless, because it removes the necessity of using cables for connections with home appliances altogether.

In a second preferred embodiment of the home automation device according to the invention, the device further comprises a slot, connected to the controller, for receiving at least one memory card.

A memory card slot provides means for storing information, such as settings or an operating system for the home automation device. The memory card may be irremovably fixed in the slot and possibly also not accessible to a user, but may alternatively also be replaceable by a user.

In a third preferred embodiment of the home automation device according to the invention, at least two of the communication interfaces are separate from each other.

When at least two of the communication interfaces are separate from each other, which in this case means that at least the physical connectors are separate, it allows for a modular approach in the construction of the home automation device. Communication interfaces which are not necessary under some circumstances may be omitted, and individual communication interfaces may be replaced more efficiently and easily when malfunctioning.

In a fourth preferred embodiment of the home automation device according to the invention, at least one communication interface is capable of communicating with a mobile phone.

While the home automation device according to the invention may be equipped with multiple communication interfaces to exchange information between the home appliances, the home automation device preferably includes at least one communication interfaces capable of communicating with a mobile phone to allow a resident, that may be away from home, to exchange information with the home automation device.

This may be either be information related to the resident, exchanged with the home automation device, such as the location of the resident with respect to the home, e.g. in order to turn on an alarm system when the resident leaves, but may also be information in relation to the home appliances connected to the home automation device, e.g. instructions to the resident to buy milk when being located close to a super market, because the contents of the refrigerator show that the availability of milk is running low.

The mobile phone may also provide instructions to the home automation device from the mobile phone itself, such as its location from a location sensor or a nearby cellular tower.

The mobile phone may in this case be a smartphone, in which case the communication with the home automation device preferably takes places through the Internet, e.g. via a wi-fi connection on the home automation device. The smart phone may in this case be provided with an app to conduct the abovementioned tasks.

In this embodiment, the mobile phone is not regarded as a home appliance in relation to the execution of the tasks of the mobile phone mentioned in relation to this embodiment, but it may be regarded as a home appliance for other tasks.

In the home automation device according to the invention, the features of the previous embodiments may also be combined, i.e. first and second; first, second and third; first, second, third and fourth; second and third; second, third and fourth; third and fourth.

The object of the invention is further achieved with a method for automating at least two home appliances with a different data communication protocol with a home automation device according to any of the preceding claims, comprising the steps of:
exchanging of information by a first communication interface of the home automation device with a first home appliance;
exchanging of the information from the first home appliance by the first communication interface to the controller;
converting the information by the controller for at least one of the other communication interfaces using the conversion means; and
exchanging of the converted information by the controller with at least one other home appliance through at least one other communication interface.

Information from a first home appliance is shared with the home automation device through a first communication interface. The home automation device will then convert the information to a format suitable to be transmitted by one or all of the other communication interfaces, and will send the information with these communication interfaces. This allows information from a first home appliance to be shared with a second home appliance, even if the first and second home appliance do not have a possibility to exchange information directly, e.g. because they use a different data communication protocol.

In a preferred embodiment of the method according to the invention, the method further comprises the step of evaluating the information by the controller received from the first communication interface before the step of converting the information or the step of exchanging the information.

While the home automation device may be programmed to convert all information received to formats suitable to be transmitted to all other home appliances connected or to all communication interfaces available in the device, it may be preferred if the controller executes an evaluation step, e.g. to determine the content of the information received and to which devices such information is relevant, or to determine which devices are connected to the home automation device, and to which data communication protocols are supported by these devices, in order to achieve a more intelligent and efficient response to the information received, thereby reducing data traffic and power consumption of the home automation device.

The object of the invention is further achieved with a combination, comprising:
a first home appliance, with a communication interface using a first data communication protocol;
a second home appliance, with a communication interface using a second data communication protocol, different from the first data communication protocol; and
a home automation device, comprising a housing, at least two communication interfaces for connecting to and communicating with the first home appliance through the first data communication protocol and connecting to and communicating with the second home appliance through the second data communication protocol, wherein each of the communication interfaces of the home automation device is arranged within the housing, and a controller, connected to each of the communication interfaces of the home automation device, for coordinating the communication interfaces, wherein the controller comprises conversion means for converting a signal from the first communication interface to a signal for the second communication interface.

The combination according to the invention comprises a first home appliance with a first communication interface which is able to exchange information with a second home appliance with a second communication interface by means of the home automation device, despite the fact that the data communication protocols of the first home appliance and the second home appliance are different.

These and other features according to the invention are further elucidated with reference to the accompanying drawings.

### BRIEF DESCRIPTION OF THE DRAWINGS

FIGS. 1A and 1B show a first and a second layer of the home automation device according to the invention;

FIG. 2 shows a combination according to the invention; and

FIG. 3 shows a flow chart of a method according to the invention.

### DETAILED DESCRIPTION OF THE INVENTION

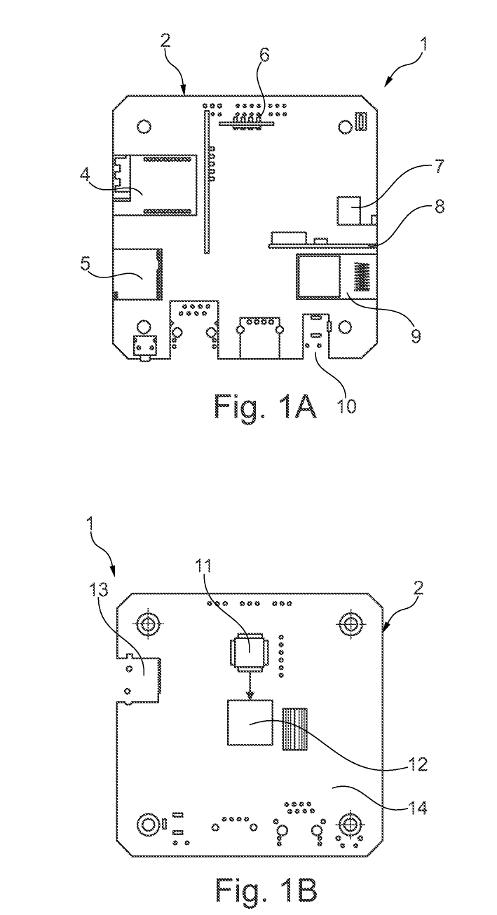

FIG. 1 shows a home automation device 1 according to the invention. On a first layer, shown in FIG. 1A, which is enclosed in a housing of which the walls 2 are shown, a plurality of communication interfaces is arranged on a circuit board 3. These communication interfaces are a ZigBee interface 4, an RF 433 interface 5, a wi-fi interface 6, a Bluetooth 4.0 interface 7, an RF 868 interface 8 and a Z-Wave interface 9. FIG. 1A also shows a DC 5V 2000 mAh power supply 10, used for powering the home automation device 1.

The communication interfaces 4, 5, 6, 7, 8, 9 are connected within the housing to a microcontroller 11 and a processor 12, arranged on a second layer shown in FIG. 1B.

Together with an SD-card slot 13, for providing storage for the home automation device 1, the microcontroller 11 and processor 12 are arranged on a circuit board 14 arranged within the walls 2 of home automation device 1.

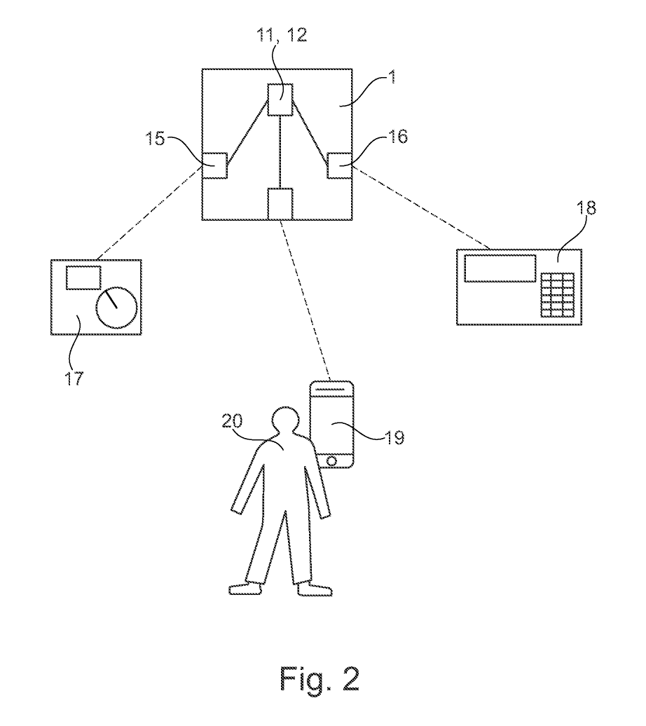

A combination according to the invention is shown in FIG. 2. The home automation device 1, drawn in a simplified view with microcontroller 11 and processor 12, connected to a first connection interface 15, and a second connection interface 16, is connected through its first connection interface 15 with a first home appliance 17, while it is connected to a second home appliance 18 through second connection interface 16. First home appliance 17 and second home appliance 18 use a different data communication protocol and are therefore in itself incompatible, but due to the presence of home automation device 1, information can be exchanged.

In addition, the home automation device 1 is also coupled to a smartphone 19, carried by a resident 20. The resident 20 may use smartphone 19 to provide instructions to the home automation device 1, which may then be distributed to one or more of the home appliances 17, 18, or may be provided with instructions from these home appliances 17, 18 via home automation device 1.

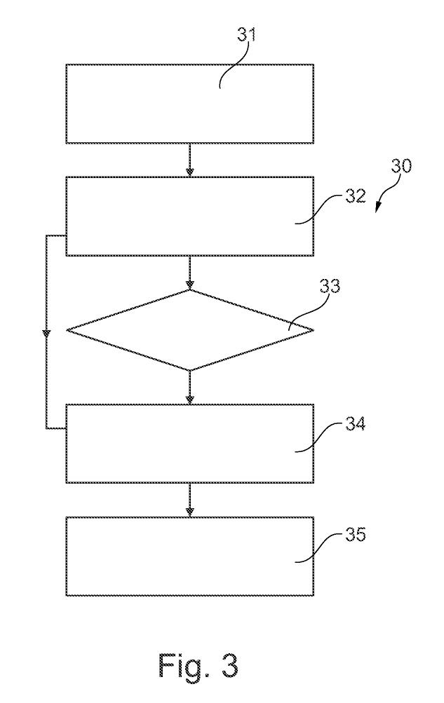

In FIG. 3, a flow chart 30 is shown of a method according to the invention. In the first step 31, a first home appliance 17 sends information through first communication interface 15 to home automation device 1. This information is sent to microcontroller 11 and/or processor 12 in step 32. Microcontroller 11 and/or processor 12 will then preferably execute an evaluation step 33 to evaluate if further actions are necessary with regard to the information received, however this step is optional. If the microcontroller 11 and/or processor 12 determines that it is necessary to send the information to a second home appliance 18, or directly after step 32, when the evaluation step 33 is omitted, then this information will be converted in step 34 such that it may be processed by the second communication interface 16, connected to second home appliance 18, after which it is transmitted to second home appliance 18.

1. A home automation device, comprising:
a housing;
at least two communication interfaces for connecting to and communicating with at least one home appliance through a data communication protocol, wherein each of the communication interfaces uses a different data communication protocol, and wherein each of the communication interfaces is arranged within the housing; and
a controller, connected to each of the communication interfaces, for coordinating the communication interfaces, wherein the controller comprises conversion means for converting a signal from a first communication interface to a signal for a second communication interface.

2. The home automation device according to claim 1, wherein at least one of the communication interfaces is a wireless interface.

3. The home automation device according to claim 1, wherein the device further comprises a slot, connected to the controller, for receiving at least one memory card.

4. The home automation device according to claim 1, wherein at least two of the communication interfaces are separate from each other.

5. The home automation device according to claim 1, wherein at least one communication interface is capable of communicating with a mobile phone.

6. A method for automating at least two home appliances with a different data communication protocol with a home automation device according to claim 1, comprising:
exchanging of information by a first communication interface of the home automation device with a first home appliance;
exchanging of the information from the first home appliance by the first communication interface to the controller;
converting the information by the controller for at least one of the other communication interfaces using the conversion means; and
exchanging of the converted information by the controller with at least one other home appliance through at least one other communication interface.

7. The method according to claim 6, further comprising evaluating the information by the controller received from the first communication interface before the step of converting the information or the step of exchanging the information.

8. A combination, comprising:
a first home appliance, with a communication interface using a first data communication protocol;
a second home appliance, with a communication interface using a second data communication protocol, different from the first data communication protocol; and
a home automation device, comprising a housing, at least two communication interfaces for connecting to and communicating with the first home appliance through the first data communication protocol and connecting to and communicating with the second home appliance through the second data communication protocol, wherein each of the communication interfaces of the home automation device is arranged within the housing, and a controller, connected to each of the communication interfaces of the home automation device, for coordinating the communication interfaces, wherein the controller comprises conversion means for converting a signal from the first communication interface to a signal for the second communication interface.

9. A method for automating at least two home appliances with a different data communication protocol with a home automation device, the method comprising:
exchanging of information by a first communication interface of the home automation device with a first home appliance;
exchanging of the information from the first home appliance by the first communication interface to a controller of the home automation device;
converting the information by the controller for at least one other communication interface using a conversion means; and
exchanging of the converted information by the controller with at least one other home appliance through at least one other communication interface.

10. The method according to claim 9, further comprising evaluating the information by the controller received from the first communication interface before the step of converting the information or the step of exchanging the information.

11. A method for automating at least two home appliances with a different data communication protocol with a home automation device according to claim 2, comprising:
exchanging of information by a first communication interface of the home automation device with a first home appliance;
exchanging of the information from the first home appliance by the first communication interface to the controller;
converting the information by the controller for at least one of the other communication interfaces using the conversion means; and
exchanging of the converted information by the controller with at least one other home appliance through at least one other communication interface.

12. A method for automating at least two home appliances with a different data communication protocol with a home automation device according to claim 3, comprising:
exchanging of information by a first communication interface of the home automation device with a first home appliance;
exchanging of the information from the first home appliance by the first communication interface to the controller;
converting the information by the controller for at least one of the other communication interfaces using the conversion means; and
exchanging of the converted information by the controller with at least one other home appliance through at least one other communication interface.

13. A method for automating at least two home appliances with a different data communication protocol with a home automation device according to claim 4, comprising:
exchanging of information by a first communication interface of the home automation device with a first home appliance;
exchanging of the information from the first home appliance by the first communication interface to the controller;
converting the information by the controller for at least one of the other communication interfaces using the conversion means; and
exchanging of the converted information by the controller with at least one other home appliance through at least one other communication interface.

14. A method for automating at least two home appliances with a different data communication protocol with a home automation device according to claim 5, comprising:
exchanging of information by a first communication interface of the home automation device with a first home appliance;
exchanging of the information from the first home appliance by the first communication interface to the controller;
converting the information by the controller for at least one of the other communication interfaces using the conversion means; and
exchanging of the converted information by the controller with at least one other home appliance through at least one other communication interface.
